(19) United States
(12) Patent Application Publication
(10) Pub. No.: US 2010/0119058 A1
(43) Pub. Date: May 13, 2010

(54) INFORMATION PROCESSING APPARATUS, INFORMATION PROCESSING METHOD, AND PROGRAM

(76) Inventors: Seiichi Matsuda, Tokyo (JP); Tomoyuki Asano, Kanagawa (JP); Masafumi Kusakawa, Tokyo (JP); Harunaga Hiwatari, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/615,421

(22) Filed: Nov. 10, 2009

(30) Foreign Application Priority Data
Nov. 11, 2008 (JP) P2008-288395

(51) Int. Cl. H04L 9/30

(52) U.S. Cl. 380/30

(57) ABSTRACT

There is provided an information processing apparatus according to the invention including a bilinear map selection unit for selecting a bilinear map used for a predetermined operation, a group selection unit for selecting at least two types of groups G₁ and G₂ used in performing the operation, a determination parameter calculation unit for calculating a determination parameter including at least either one of a computation amount required for the predetermined operation and an information amount for the predetermined operation based on each of the selected at least two types of the groups, and a group decision unit for deciding a group used in performing the operation based on the determination parameter. The group decision unit exchanges contents of the groups G₁ and G₂ when the computation or information amount for the group G₂ is more than that for the group G₁.

### BACKGROUND OF THE INVENTION

1. Field of the Invention

The present invention relates to an apparatus for processing information, a method of processing information, and a program.

2. Description of the Related Art

Nowadays businesses of distributing contents such as music and video have been increased in importance along with the popularization and development of mobile phones, digital appliances, and the like, as well as, personal computers (PCs). Although the businesses of distributing the contents include pay-per-view broadcast services utilizing CATV, satellite broadcast, Internet, and the like, and sales of contents utilizing a physical medium such as CD and DVD, in any case there is a need for establishing techniques to allow only subscribers to access the contents.

Various key sharing methods are proposed as examples of the techniques in which an operation referred to as a bilinear map is used (for example, see the following non-patent documents: C. Delerablee, “Identity-Based Broadcast Encryption with Constant Size Ciphertexts and Private Keys,” ASIACRYPT 2007, LNCS 4833, pp. 200-215, 2007 (hereinafter, referred to as Non-Patent Document 1); and C. Delerablee, R. Paillier, and D. Pointcheval, “Fully Collusion Secure Dynamic Broadcast Encryption with Constant-Size Ciphertexts or Decryption Keys,” Pairing-Based Cryptography-Pairing 2007, Lecture Notes in Computer Science 4575, pp. 39-59, Springer, 2007 (hereinafter referred to as Non-Patent Document 2). The bilinear map is a function mapping elements in two additive groups to elements in a multiplicative group in which linearity holds between input two elements and an output element.

### SUMMARY OF THE INVENTION

In the methods described in Non-Patent Document 1 and Non-Patent Document 2, there is also a need for selecting two kinds of groups in executing the methods. Depending on the selected groups, however, each method has an issue with variations in an amount of computation and an amount of information for the entire scheme.

In light of the foregoing, it is desirable to provide a new and improved information processing apparatus, method, and program in which an amount of computation and an amount of information for an entire operation scheme can be reduced in an operation using a bilinear map.

According to an embodiment of the present invention, there is provided an information processing apparatus including a bilinear map selection unit for selecting a bilinear map used for a predetermined operation, a group selection unit for selecting at least two types of groups G₁ and G₂ used in performing the operation, a determination parameter calculation unit for calculating a determination parameter including at least either one of a computation amount required for the predetermined operation and an information amount for the predetermined operation based on each of the selected at least two types of the groups, and a group decision unit for deciding a group used in performing the operation based on the determination parameter. The group decision unit exchanges contents of the groups G₁ and G₂ when the computation amount or information amount for the group G₂ is more than that for the group G₁.

According to this configuration, the bilinear map selection unit selects the bilinear map used for the predetermined operation, and the group selection unit selects at least two types of groups G₁ and G₂ used in performing the operation. In addition, the determination parameter calculation unit calculates the determination parameter including at least either one of the amount of computation required for the predetermined operation and the amount of information for the predetermined operation based on each of the selected at least two types of the groups G₁ and G₂. Furthermore, the group decision unit decides a group used in performing the operation based on the determination parameter. The group decision unit also exchanges contents of the group G₁ and the group G₂ when an amount of computation or an amount of information for the group G₂ is more than that for the group G₁.

The information processing apparatus may further include a storage unit in which a detail of the operation using the bilinear map is recorded, and the determination parameter calculation unit may calculate the determination parameter with reference to the detail of the operation recorded in the storage unit.

The group G₁ and the group G₂ preferably different from each other in that elements belonging to respective groups are different.

The groups selected by the group selection unit are preferably groups of a prime number order having a predetermined number of bits.

The bilinear map is preferably a map for points situated on an elliptic curve. The bilinear map may be a Tate pairing. The bilinear map may be an Ate pairing.

The predetermined operation may be an operation based on a public key distribution scheme. The predetermined operation may be an operation based on an ID based public key distribution scheme.

According to another embodiment of the present invention, there is provided an information processing method, including the steps of selecting a bilinear map used for a predetermined operation, selecting at least two types of groups G₁ and G₂ used in performing the operation, calculating a determination parameter including at least either one of a computation amount required for the predetermined operation and an information amount for the predetermined operation based on each of the selected at least two types of the groups, and determining whether the computation amount or information amount for the group G₂ is more than that for the group G₁, and when it is affirmative, exchanges contents of the groups G₁ and G₂.

According to another embodiment of the present invention, there is provided a program for causing a computer to execute a bilinear map selection process for selecting a bilinear map used for a predetermined operation, a group selection function for selecting at least two types of groups G₁ and G₂ used in performing the operation, a determination parameter calculation function for calculating a determination parameter including at least either one of a computation amount required for the predetermined operation and an information amount for the predetermined operation based on each of the selected at least two types of the groups, and a function for determining whether the computation amount or information amount for the group G₂ is more than that for the group G₁, and when it is affirmative, for exchanging contents of the groups G₁ and G₂.

According to this configuration, a computer program is stored in a storage unit included in a computer, and read and executed by CPU included in the computer so that the computer program causes the computer to operate as the above-mentioned apparatus for processing information. In addition, there is also provided a computer readable recording medium in which the computer program is recorded. The recording medium may be, for example, a magnetic disk, an optical disk, a magneto-optical disk, a flush memory, and so on. Furthermore, the above-mentioned computer program may be distributed via a network without using a medium.

According to an embodiment of the present invention, an amount of computation and an amount of information for the entire operation scheme can be reduced in an operation using a bilinear map.

### BRIEF DESCRIPTION OF THE DRAWINGS

FIG. 1 is a block diagram illustrating a structure of an information processing apparatus according to a first embodiment of the present invention;

FIG. 2 is a flowchart illustrating an information processing method according to the first embodiment of the present invention;

FIG. 3 is a diagram illustrating an application example of the information processing apparatus according to the first embodiment;

FIG. 4 is a block diagram illustrating an application example of the information processing apparatus according to the first embodiment;

FIG. 5 is a flowchart illustrating a method of generating public information in Non-Patent Document 2;

FIG. 6 is a flowchart illustrating a method of generating a key in Non-Patent Document 2;

FIG. 7 is a flowchart illustrating an encryption method in Non-Patent Document 2;

FIG. 8 is a flowchart illustrating a computation method in Non-Patent Document 2;

FIG. 9 is a flowchart illustrating a decryption method in Non-Patent Document 2;

FIG. 10 is a flowchart illustrating a computation method in Non-Patent Document 2;

FIG. 11 is a diagram illustrating a variation in information amounts depending on application or non-application of the information processing method according to the first embodiment;

FIG. 12 is a diagram illustrating a variation in information amounts depending on application or non-application of the information processing method according to the first embodiment; and

FIG. 13 is a block diagram illustrating a hardware structure of an information processing apparatus according to each embodiment of the present invention.

### DETAILED DESCRIPTION OF EMBODIMENT

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

A description will be provided in the order as follows:

### (1) Purpose

### (2) Pairing on Elliptic Curve

### (3) First Embodiment

### (3-1) Structure of Information Processing Apparatus

### (3-2) Information Processing Method

### (3-3) Application Example of Information Processing Apparatus

Cipher Processing System

Application Example of Information Processing Apparatus

Method of Generating Public Information According to Methodology in Non-Patent Document 2

Method of Generating Key According to Methodology in Non-Patent Document 2

Encryption Method According to Methodology in Non-Patent Document 2

Decryption Method According to Methodology in Non-Patent Document 2

Issues with Method of Non-Patent Document 2

Comparisons of Computation Amount and Information Amount

### (4) Hardware Structure of Information Processing Apparatus According to Each Embodiment of the Present Invention

### (5) Summary

### <Purpose>

In advance of the description of an information processing apparatus and an information processing method according to each of embodiments of the present invention, we will now describe the purpose of embodiments of the present invention in detail taking a cipher process for a distribution of a public key as an example of an operation using a bilinear map

The bilinear map is a function mapping elements in two additive groups to an element in a multiplicative group in which linearity holds between input two elements and an output element, as described above. There are two commonly used bilinear maps, such as Weil pairing and Tate pairing defined on an elliptic curve. Hereinafter, these two types of pairing are collectively designated as pairing.

The pairing in itself has been recognized as an attack scheme against an elliptic curve cipher which reduces the discrete logarithm issue on an elliptic curve to the discrete logarithm issue on a finite field. However, since innovative schemes, such as the three-party key sharing scheme taught by Joux or the ID based key sharing scheme taught by Sakai et al., utilizing pairing, have been produced, applied researches utilizing the pairing have been actively conducted.

It was considered that the pairing had a disadvantage over other fundamental technologies in that its computation cost was higher than that of the other fundamental technologies. At present, however, since the η_{T} pairing or the Ate pairing has been proposed as a fast calculation algorithm, it is possible to calculate the pairing at substantially the same cost (in more detail, the same order) as the RSA cipher or the elliptic curve cipher.

Some cipher schemes utilizing the pairing will require a parameter, such as a size of a source of an input to the pairing or an output from the pairing, to be set appropriately in order to ensure security of the schemes. In a current security standard, groups satisfying G₁=G₂ can be constructed by utilizing an elliptic curve refereed to as a supersingular curve and a value of the pairing can be calculated by utilizing a fast η_{T} pairing.

However, when using a parameter achieving a higher security standard, for reasons to be described later, it is desirable to select groups satisfying G₁≠G₂. The calculation of the value of the pairing uses then the Ate pairing on the elliptic curve referred to as an ordinary curve. In this instance, there is an issue in that amounts of computation and information for an entire scheme vary significantly depending on selection of the groups to be used in a cipher scheme consisting of a central facility generating public information, a user key, and so on, and a plurality of users.

In this connection, the inventors have been dedicated to developing an information processing apparatus and an information processing method in which amounts of computation and information for an entire operation scheme can be reduced in an operation using a bilinear map, while maintaining a higher security standard. Consequently, the inventors have contrived an information processing apparatus and an information processing method to be described later.

### <Pairing on Elliptic Curve>

We will now briefly describe a pairing on an elliptic curve in advance of the description of an information processing apparatus and an information processing method according to each embodiment of the present invention.

### [1. Finite Field, Elliptic Curve]

Let p be a prime number and q be a power of the prime number p such that q=p^{m}. A finite field F_{q} is an m-th degree extension field of a prime field Fₚ. An elliptic curve E defined on the finite field F_{q} is given in the form of y²=x³+ax+b, (a, bεF_{q}), and a group of elements having order r is denoted by E(F_{q})[r] where an order of a subset is r.

One of parameters depending on the elliptic curve is an embedding degree k which is defined as a minimum integer satisfying r|q^{k}−1. When the elliptic curve E is an elliptic curve referred to as an ordinary curve, there is a twist E′ of E of degree d (d=2, 3, 4, 6) defined on F_{q}, and the elliptic curve E has an isomorphic map φ_{d} written in the following Eq. (1). When the elliptic curve E is an elliptic curve referred to as a supersingular curve, the elliptic curve E has an isomorphic map referred to as a distortion map as written in the following Eq. (2).

φ_{d}:E′(F_{q})→E(F_{q}_{^{s}}) (1)

φ:E(F_{q})→E(F_{q}_{^{k}}), k≦6 (2)

### [2. Bilinear Map]

Let G₁, G₂ and G_{T} be cyclic groups of an order r, respectively. Then a bilinear map e can be defined as the following Eq. (3).

e: G₁×G₂→G_{T} (3)

In addition, this bilinear map e satisfies two properties for any GεG₁, HεG₂, and a, bεZₚ, as follows.

1. Bilinearity: e(aG, bH)=e(G, H)^{ab}

2. Nondegeneracy: e(G, H)≠1 (in case of G≠1 or H≠1)

On one hand, in the case of a supersingular curve, let be given such that G₁=G₂=E(F_{q})[r], and, on the other hand, in the case of an ordinary curve, let be given such that G₁=E(F_{q})[r] and G₂=E′(F_{q})[r] using a twist E′ defined on a finite field F_{q}. In either curves, G_{T} is given in the following Eq. (4). In order to derive a non-obvious value of a pairing, it is desirable to lift points in G₂ to E(F_{q}^{k}) using an isomorphic map. Hereinafter, the notation “F_{q}^{k}” represents a k-th degree extension field of F_{q}. On one hand, in the case of the supersingular curve, we can derive an element φ(P) linearly independent from PεG₁ using a distortion mapφ, as represented in the following Eq. (5). On the other hand, in the case of the ordinary curve, the following Eq. (6) is derived for QεG₂ using an isomorphic mapφ_{d} of the twist E′.

G_{T}=aεF_{q}_{^{k}}*|a^{r}≡1} (4)

φ(P)εE(F_{q}_{^{k}})[r] (5)

φ_{d}(Q)εE(F_{q}_{^{k}})[r] (6)

It should be noted that some general example of the above-mentioned bilinear map include, for example, Weil pairing, Tate pairing, and Ate pairing.

### [3. Parameter Setting in Operation Using Bilinear Map]

The setting of parameters in an operation using a bilinear map involves determining a size of an additive group, which is input to a pairing, on an elliptic curve and a size of a finite field to which a multiplicative group, which is output from the pairing, belongs, as is the case with the elliptical curve. In a current security standard, i.e., 80-bit security, in connection with the size of the additive group, an order r of a subset may be set to approximately 160-bit due to a discrete logarithm issue on the elliptic curve. In addition, in connection with the size of the finite field to which the multiplicative group belongs, the finite field |F_{q}^{k}| may be set to approximately 1024-bit due to a discrete logarithm issue on the finite field.

Specific parameters are such that an embedding degree k=6, |r|=160, |F_{q}|=171, and |F_{q}⁶|=1026, for example. In this instance, amounts of information for elements of G₁ and G₂, respectively, are not different from each other in either of the supersingular curve or the ordinary curve. In the case of achieving higher security than the current security standard, the amounts of information for the elements of G₁ and G₂, respectively, are different from each other depending on a used elliptic curve. For example, parameters satisfying 128-bit security are such that a degree of a subset |r| is approximately 6, and a finite field |F_{q}^{k}| is approximately 3072-bit.

On one hand, since an embedding degree for the supersingular curve is up to k=6, it is desirable to set a size of a field of definition |F_{q}| to 512-bit. In addition, an amount of information for PεG₁ is 1024-bit.

On the other, in the case of the ordinary curve, although an embedding degree k can be any values, a degree of an isomorphic map is up to 6. Although the lifting of elements of G₂ to E(F_{q}^{k})[r] may be issueatic, this can be dealt with by increasing an extension degree of a field of definition of a twist. That is to say, let d be a degree of the twist, let e be an expansion degree such that k=ed, and let G₂ be a group E′(F_{q}^{e})[r] on the twist. Any elements of G₂ will be mapped to E(F_{q}^{k})[r] by means of φ_{d}.

In the case of the supersingular curve, both of the amounts of information for the elements belonging to G₁ and G₂, respectively, will increase in order to increase a size of F_{q}. In the case of the ordinary curve, on the other hand, the amount of information for G₁ will not change and the amount of information for the elements belonging to G₂ will increase. Since the larger the field of definition is, the more an amount of computation for the group increases by O((lg q)²), the ordinary curve may have an advantage over the supersingular curve also in terms of the amount of computation.

### First Embodiment

### Structure of Information Processing Apparatus

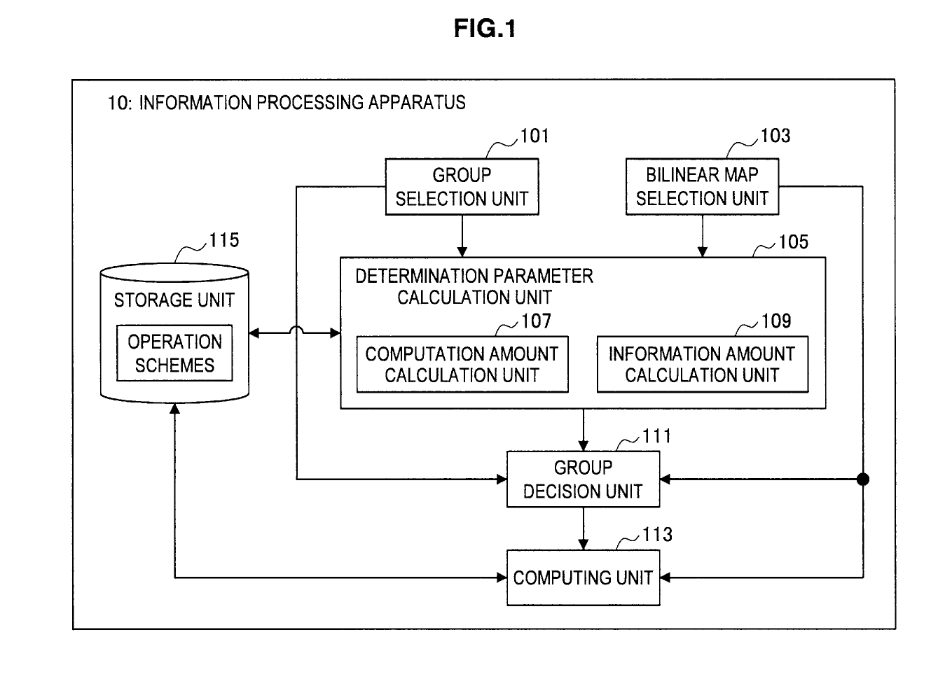

A structure of an information processing apparatus according to a first embodiment of the present invention will now be described, in detail. FIG. 1 is a block diagram illustrating the structure of the information processing apparatus according to this embodiment.

An information processing apparatus 10 according to this embodiment is an apparatus capable of performing predetermined operations utilizing a bilinear map. The information processing apparatus 10 according to this embodiment mainly includes a group selection unit 101, a bilinear map selection unit 103, a determination parameter calculation unit 105, a group decision unit 111, a computing unit 113 and a storage unit 115, for example, as shown in FIG. 1.

The group selection unit 101 may include, for example, Central Processing Unit (CPU), Read Only Memory (ROM), Random Access Memory (RAM), and so on. The group selection unit 101 randomly selects a prime number p of λ-bit, and randomly selects additive groups G₁ and G₂ of an order p as well as a cyclic multiplicative group G_{T}.

The group selection unit 101 transmits the selected groups G₁, G₂, and G_{T} to the determination parameter calculation unit 105 and the group decision unit 111 to be described later.

The bilinear map selection unit 103 may have, for example, CPU, ROM, RAM, and so on. The bilinear map selection unit 103 selects a bilinear map being such that G₁×G₂→G_{T}, once the group selection unit 101 selects the groups G₁, G₂, and G_{T}.

The bilinear maps selected by the bilinear map selection unit 103 preferably forms a pairing such that information amounts for elements belonging to two groups G₁ and G₂ used for a map operation are different from each other. One example of such bilinear maps may be maps transforming points situated on a predetermined elliptic curve to a certain finite field, and, in particular, a pairing, such as Tate pairing and Ate pairing, may be listed. The Tate pairing and the Ate pairing allow an embedding degree k of the elliptic curve to be set to any values, and allow options of the elliptic curve to be broadened.

The following Table 1 illustrates a comparison between an information amount for parameters in a η_{T} pairing which can be calculated fast and an information amount for the Ate pairing. In the case of the η_{T} pairing, since a supersingular curve is used as an elliptic curve, an embedding degree k of the elliptic curve will be up to 6. Thus, in the case of the η_{T} pairing, when k=6, the degree r is set to 512-bit and a size of a finite field F_{q}^{k} is set to 3072-bit in order to achieve 128-bit security. On the other hand, in the case of the Ate pairing, since it is possible to set an embedding degree k of the elliptic curve to any values, the embedding degree k=12 is allowed in order to achieve 128-bit security. Therefore, in the case of the Ate pairing, it is possible to set the degree r to 256-bit and a size of a finite field F_{q}^{k} to 3072-bit, and it is appreciated that the Ate pairing has an advantage over the η_{T} pairing in terms of the information amount.

TABLE 1

| SECURITY | | η_{T} pairing | | Ate pairing |
|---|---|---|---|---|
| LEVEL | SECURE BIT LENGTH | k = 4 | k = 6 | k = 12 |
| 80-bit | r: 160-bit OR MORE | 256-bit | 171-bit | — |
| | F_{q}^{k}: 1024-bit OR MORE | 1024-bit | 1026-bit | — |
| 128-bit | r: 256-bit OR MORE | 768-bit | 512-bit | 256-bit |
| | F_{q}^{k}: 3072-bit OR MORE | 3072-bit | 3072-bit | 3072-bit |

It should be noted that the information processing apparatus according to this embodiment allows us to make use of any bilinear map that forms a pairing in which information amounts for elements belonging to two groups G₁ and G₂, which are used for the map operations, are different from each other.

The bilinear map selection unit 103 transmits information regarding the selected bilinear map to the determination parameter calculation unit 105, the group decision unit 111, and the computing unit 113, to be described later.

The determination parameter calculation unit 105 may have, for example, CPU, ROM, RAM, and so on. The determination parameter calculation unit 105 calculates a determination parameter including at least one of an amount of computation required for operations performed by the computing unit 113 to be described later and an information amount for the operations based on the transmitted information regarding the groups and the bilinear map. In calculating the determination parameter, the determination parameter calculation unit 105 can calculate the determination parameter with reference to detailed information regarding an operation scheme which has been recorded in the storage unit 115 or the like to be described later. The determination parameter calculation unit 105 may also have a computation amount calculation unit 107 and an information amount calculation unit 109, for example, as shown in FIG. 1.

The computation amount calculation unit 107 may have, for example, CPU, ROM, RAM, and so on. The computation amount calculation unit 107 calculates the amount of computation performed by the computing unit 113 with reference to the detailed information regarding the operation scheme recorded in the storage unit 115 or the like, and parameters or the like set in preparation for performing the operation. One example of the computation amount includes, for example, a computation amount of addition, multiplication, power, inverse element operation, bilinear map operation or the like, which are performed in a predetermined operation. Such computation amount can be uniquely determined depending on set parameters or the like, once operations to be performed by the computing unit 113 have been determined.

The information amount calculation unit 109 may have, for example, CPU, ROM, RAM, and so on. The information amount calculation unit 109 calculates the information amount for information generated in the operations performed by the computing unit 113 with reference to the detailed information regarding the operation scheme recorded in the storage unit 115 or the like, and the parameters set in preparation for performing the operation or the like. The information generated in the operation varies depending on types of operations performed by the computing unit 113. In the case where an operation for a cipher process utilizing a bilinear map, for example, is performed by the computing unit 113, the information generated in the operation may include, for example, information for a public key, information for a ciphertext, information for a secret key, and so on. In addition, the computation amount for the information generated in the operation may be, for example, a data size of data corresponding to the information generated in the operation and can be represented by a number of bits of the corresponding data.

The determination parameter calculation unit 105 arranges the computation amount calculated by the computation amount calculation unit 107 and the information amount calculated by the information amount calculation unit 109 into a determination parameter and transmits the determination parameter to the group decision unit 111 to be described later.

It should be noted that the determination parameter calculation unit 105 may append any information representing a computation cost, a computation load, or the like to the determination parameter, in addition to the computation amount required for a predetermined operation and the information amount for the predetermined operation. Furthermore, the determination parameter calculation unit 105 may transmit a product of the calculated computation amount and the calculated information amount as the determination parameter to the group decision unit 111.

The group decision unit 111 may have, for example, CPU, ROM, RAM, and so on. The group decision unit 111 decides groups used by the computing unit 113 in performing the operation based on the determination parameter transmitted from the determination parameter calculation unit 105. In particular, the group decision unit 111 exchanges contents of a group G₁ and a group G₂ when a computation amount or information amount for the group G₂ selected by the group selection unit 101 is more than that for the group G₁ selected by the group selection unit 101. Thus the groups used in the operation to be performed by the computing unit 113 would be decided.

As a result of such processing, when a computation cost for group operations in the group G₂ is more than that for group operations in the group G₁ and the operations in the group G₂ are dominant for the entire operation, the computation amount and the information amount for the entire operation can be effectively reduced.

The group decision unit 111 transmits information regarding the decided groups to the computing unit 113. The group decision unit 111 may also record the information regarding the decided groups in the storage unit 115 and so on, in correlation with information regarding date and hour of deciding the groups.

The computing unit 113 may have, for example, CPU, ROM, RAM, and so on. The computing unit 113 performs a predetermined operation utilizing a plurality of groups transmitted from the group decision unit 111, the bilinear map transmitted from the bilinear map selection unit 103, set parameters for the operation, and so on. The operation performed by the computing unit 113 is an operation utilizing the bilinear map. One example of such an operation may include an operation for various cipher processes utilizing the bilinear map. One example of the operation for the cipher process utilizing the bilinear map may include, for example, a cipher process based on a public key distribution scheme, an operation for a cipher process based on an ID based key sharing scheme, and the like.

The operation performed by the computing unit 113 is not limited to the cipher process utilizing the bilinear map, as described above, but may be whatever computation processes that use the bilinear map.

The storage unit 115 stores the detailed information regarding the operation scheme performed by the computing unit 113 according to this embodiment. Some of the detailed information regarding the operation scheme may be listed, for example, as execution data of a program for the operation performed by the computing unit 113, a source code of the program, a database in which various settings regarding the operation have been recorded in advance. The storage device 115 may also allow, in addition to these various data, various parameters, intermediate results, and so on, which are needed to be stored by the information processing apparatus 10 in performing some processes, or a variety of databases and so on to be appropriately stored. The storage unit 115 can be freely read from/written to by the group selection unit 101, bilinear map selection unit 103, determination parameter calculation unit 105, computation amount calculation unit 107, information amount calculation unit 109, group decision unit 111, computing unit 113, and so on.

An example of features of an information processing apparatus 10 according to this embodiment has been described above. Each of above components may be configured using a general purpose member or circuit, or may be configured with a dedicated hardware for a feature of each component. In addition, a feature of each component may be achieved by only CPU or the like. Thus a configuration used herein can be appropriately modified depending on state of the art at the time of implementing this embodiment.

### <Information Processing Method>

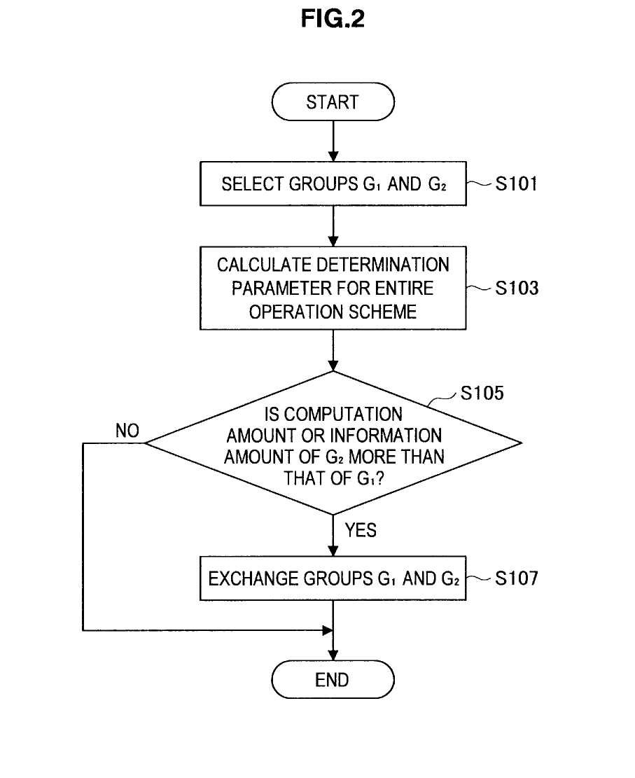

An information processing method according to this embodiment will now be described, in detail. FIG. 2 illustrates a flowchart illustrating the information processing method according to this embodiment.

First, a group selection unit 101 of an information processing apparatus 10 according to this embodiment randomly selects a prime number p of i-bit, and randomly selects cyclic additive groups G₁ and G₂ of an order p (step S101). In addition, the group selection unit 101 may select a cyclic multiplicative group G_{T} in conjunction with selection of the groups G₁ and G₂. The group selection unit 101 transmits the selected groups to a determination parameter calculation unit 105.

Furthermore, a bilinear map selection unit 103 of the information processing apparatus 10 selects a bilinear map in association with selection of the groups and transmits the bilinear map to the determination parameter calculation unit 105.

Second, the determination parameter calculation unit 105 calculates a determination parameter for an entire operation scheme based on the groups G₁ and G₂ selected by the group selection unit 101 (step S103). The determination parameter calculation unit 105 transmits the calculated determination parameter to a group decision unit 111.

Subsequently, the group decision unit 111 of the information processing apparatus 10 determines the groups G₁ and G₂ selected by the group selection unit 101 based on the calculated determination parameter. In particular, the group decision unit 111 performs this determination based on the magnitude relation between the computation amount or information amount for the group G₂ and the computation amount or information amount for the group G₁ (step S105).

When the computation amount or information amount for the group G₂ is less than the computation amount or information amount for the group G₁, on one hand, the group decision unit 111 would not exchange contents of the group G₁ and the group G₂ selected by the group selection unit 101, but decide so that these groups are used in the operation.

When the computation amount or information amount for the group G₂ is more than the computation amount or information amount for the group G₁, on the other hand, the group decision unit 111 would exchange the contents of the group G₁ and the group G₂ (step S107). Thus the group decision unit 111 decides so that the group G₁ and the group G₂ whose contents have been exchanged are used in the operation.

The information processing method according to this embodiment can reduce amounts of computation and information for an entire operation scheme in an operation utilizing a bilinear map by exchanging contents of groups with each other when a computation amount or information amount for a group G₂ is more than a computation amount or information amount for a group G₁.

<Application Example of Information Processing Apparatus According to this Embodiment>

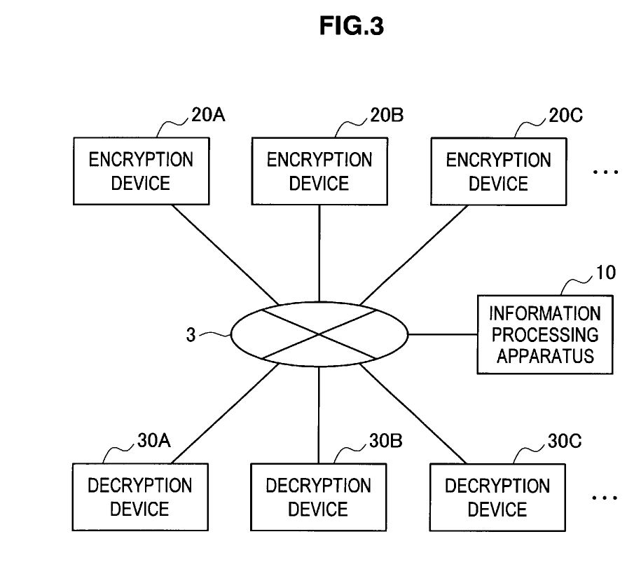

An application example of an information processing apparatus and an information processing method according to this embodiment in connection with an example of a cipher process utilizing a bilinear map will now be described, in detail, with reference to FIGS. 3-12. It should be noted that the cipher process utilizing the bilinear map to be described later is a cipher process based on a public key distribution scheme, as disclosed in Non-Patent Document 2.

Hereinafter, we will describe a case where security equal to or more than 128-bit security is assured and an ordinary curve being such that G₁≠G₂ is used.

### [Cipher Processing System]

Referring to FIG. 3, we will now briefly describe a cipher processing system in a methodology disclosed in Non-Patent Document 2, and so on. FIG. 3 illustrates an application example of an information processing apparatus according to this embodiment.

A cipher processing system mainly includes a communication network 3, an information processing apparatus 10, encryption devices 20A, 20B, and 20C, and decryption devices 30A, 30B, and 30C, as shown in FIG. 3, for example.

The communication network 3 is a communication line network that connects the information processing apparatus 10, the encryption devices 20, and the decryption devices 30 such that they can communicate in either one-way or two-way with each other. The communication network 3 may include a public network or a private network. In addition, the communication network 3 is limited neither to a wired network nor a wireless network. One example of the public network may be, for example, Internet, Next Generation Network (NGN), telephone network, satellite communication network, or multicasting network, on one hand. One example of the private network may be, for example, WAN, LAN, IP-VAN, Ethernet (registered mark), or wireless LAN.

In this application example, the information processing apparatus 10 determines various parameters and so on, which are used in an operation for a cipher process, as well as generates a secret key, which is specific to an individual user, including a public key and a secret key. The information processing apparatus 10 reveals some system parameters capable of being published and public keys as well as distributes respective secret keys to the encryption devices 20 and the decryption devices 30 via a secure communication path. This information processing apparatus 10 will be owned by a central facility generating and managing the public keys and the secret keys.

The encryption device 20 encrypts some contents using a generated and published public key and distributes the contents to each decryption device via the communication network 3. This encryption device 20 may be owned by any third parties including an owner of the information processing apparatus 10 and an owner of the decryption device 30. It should be noted that, although there are only three encryption devices shown in FIG. 3, it is not intended to be limited to the above-mentioned example, but there may be any number of the encryption devices 30.

The decryption device 30 is capable of decrypting and utilizing the encrypted contents which have been distributed from the encryption device 20. This decryption device 30 will be owned by each individual subscriber.

It should be noted that the information processing apparatus 10, the encryption devices 20, and the decryption devices 30 are not intended to be limited to a computer (regardless of a notebook computer or a desktop computer), such as a personal computer, but may be any devices including a communication facility via a network. The device including the communication facility may include, for example, an information appliance, such as a personal digital assistant (PDA), a home game machine, a DVD/HDD recorder, a Blu-ray recorder, or a television receiver, and a tuner, a decoder, and so on for television broadcast. In addition, the information processing apparatus 10, the encryption device 20, and the decryption device 30 may be a portable device, such as a portable game machine, a mobile phone, a portable video/audio player, a PDA, or a PHS, which can be carried by the subscriber.

[Structure of Information Processing Apparatus According to this Application Example]

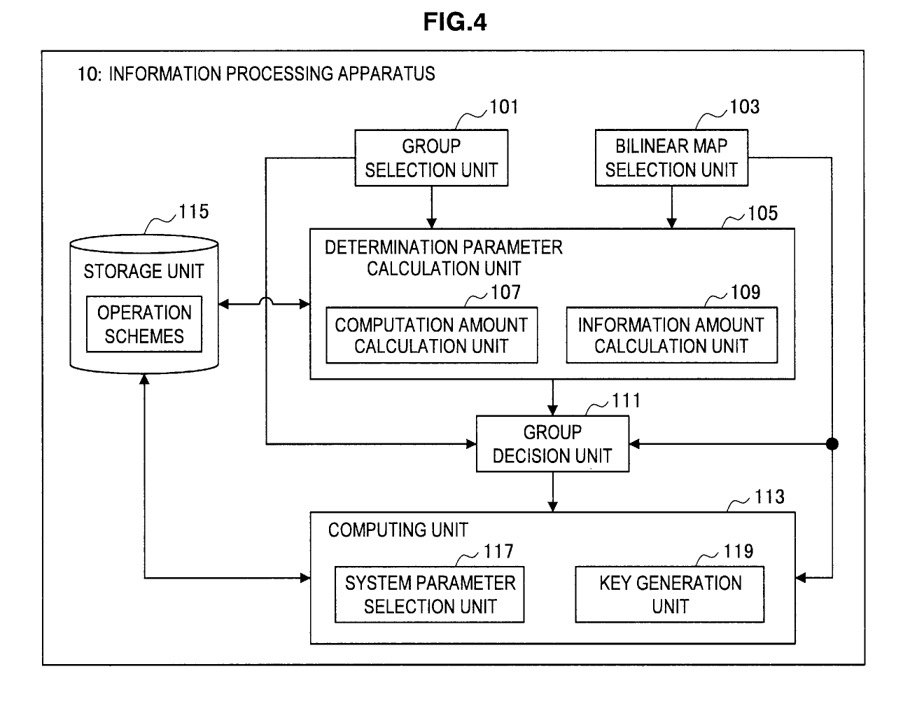

Referring to FIG. 4, we will now briefly describe a structure of an information processing apparatus 10 according to this application example. FIG. 4 is a block diagram illustrating the structure of the information processing apparatus 10 according to this application example.

The information processing apparatus 10 according to this application example may mainly have a group selection unit 101, a bilinear map selection unit 103, a determination parameter selection unit 105, a group decision unit 111, a computing unit 113, and a storage unit 115, for example, as shown in FIG. 4.

A detailed description of the group selection unit 101, the bilinear map selection unit 103, the determination parameter selection unit 105, the group decision unit 111, and the storage unit 115 according to this application example will be omitted, since each of these units has a similar function and a substantially identical effect as that of the above-mentioned information processing apparatus 10.

The computing unit 113 in this application example is a computing unit, which performs a setup process and a join process among four basic processes in the methodology described in Non-Patent Document 2. Details of the setup process and the join process will be later described in detail. This computing unit 113 generates public information based on the methodology described in Non-Patent Document 2, as well as generates a secret key for each user based on the methodology described in the same document. The computing unit 113 may further include a system parameter selection unit 117 and a key generation unit 119, for example, as shown in FIG. 4. The system parameter selection unit 117 is a computing unit performing the setup process and the key generation unit 119 is a computing unit performing the join process.

The system parameter selection unit 117 may have, for example, CPU, ROM, RAM, and so on. The system parameter selection unit 117 sets parameters (hereinafter, referred to as system parameters) of the cipher processing system using the groups decided by the group decision unit 111 and the bilinear map selected by the bilinear map selection unit 103 based on the methodology described in Non-Patent Document 2. In addition, the system parameter selection unit 117 reveals information necessary to be published among the set system parameters to the encryption device 20 and the decryption device 30 as public information. This public information is revealed via a communication control unit (not shown) provided in the information processing apparatus 10 according to this application example.

Furthermore, the system parameter selection unit 117 records the selected system parameters in the storage unit 115.

The key generation unit 119 may include, for example, CPU, ROM, RAM, and so on. The key generation unit 119 generates a secret key specific to each user using the groups decided by the group decision unit 111, the bilinear map selected by the bilinear map selection unit 103, and the system parameters selected by the system parameter selection unit 117. The secret key specific to the user includes two types of keys, that is to say, a secret key which only the user keep secret and a public key revealed to other users. The key generation unit 119 generates these two types of secret keys based on the methodology described in Non-Patent Document 2. The key generation unit 119 sends the secret key including the generated pubic key and secret key to a relevant user via a secure communication path as well as reveals the public key to other users. Sending of the secret key and revealing of the public key will be performed by a communication control unit (not shown) of the information processing apparatus 10 according to this application example.

In addition, the key generation unit 119 records the generated secret key in the storage unit 115 in association with user information regarding the relevant user.

An example of the information processing apparatus 10 according to this application example has been described above. Each of above components may be configured using a general purpose member or circuit, or may be configured with a dedicated hardware for a feature of each component. In addition, the feature of each component may be achieved by CPU or the like. Thus a configuration used herein can be appropriately modified depending on state of the art at the time of implementing this application example.

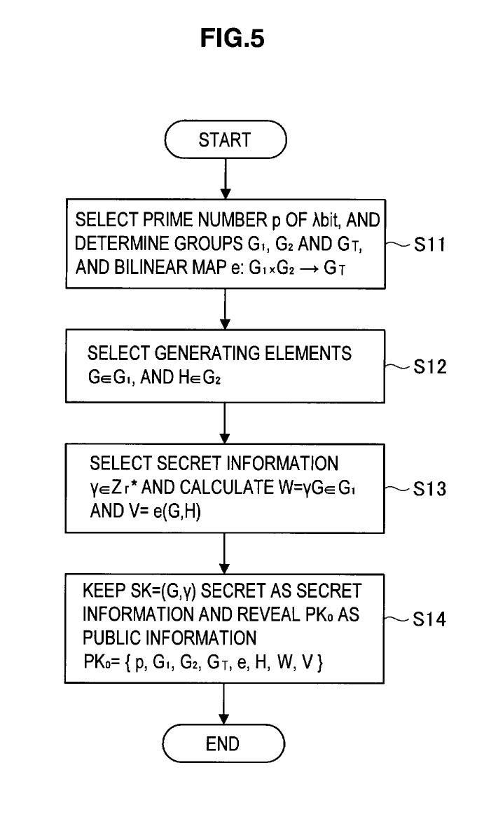

A public key distribution method disclosed in Non-Patent Document 2 will now be described, in detail, with reference to FIGS. 5 to 10. The methodology in Non-Patent Document 2 consists in four basic processes including setup, join, encryption, and decryption processes. The setup process and the join process among the four processes are processes performed in the information processing apparatus 10 shown in FIG. 3, as described above. In addition, the encryption process among the four basic processes is a process performed in the encryption device 20 shown in FIG. 3. Moreover, the decryption process among the four basic processes is a process performed in the decryption device 30 shown in FIG. 3.

[Method of Generating Public Information in Methodology According to Non-Patent Document 2]

First of all, a setup process, i.e., a method of generating public information, in a methodology according to Non-Patent Document 2 will now be described, in detail, with reference to FIG. 5. FIG. 5 is a flowchart illustrating the method of generating the public information according to Non-Patent Document 2.

The setup process is a process generating public information that is performed by a central facility having an information processing apparatus according to this application example only once when building a system. The central facility determines a security parameter λ and the information processing apparatus 10 performs the setup process, which is to be described later, using the input security parameter.

First, the information processing apparatus 10 selects a prime number p of X-bit, and selects additive groups G₁ and G₂ of an order of p (the prime number order p) and a cyclic multiplicative group G_{T} as well as determines a bilinear map e: G₁×G₂→G_{T} (step S11). It should be appreciated that selection of the groups is performed by a group selection unit 101 in this application example, and the groups used in an operation by a group decision unit 111 are determined. In addition, selection of the bilinear map is performed by a bilinear map selection unit 103 in this application example.

Second, a system parameter selection unit 117 in the information processing apparatus 10 selects generating elements GεG₁ and HεG₂ (step S12).

Next, the system parameter selection unit 117 in the information processing apparatus 10 selects secret information γεZᵣ* and calculates W=γGεG₁ as well as calculates V=e(G, H)εG_{T} (step S13).

Thereafter, the system parameter selection unit 117 keeps SK=(G, γ) secret as secret information (master key) as well as builds PK₀ according to the following Eq. (101) and reveals it as public information (step S14).

PK₀={p, G₁, G₂, G_{T}, e, H, W, V} (101)

Next, the information processing apparatus 10 reveals PK₀ derived by performing the setup process as public information for an entire system.

### [Method of Generating Key in Methodology According to Non-Patent Document 2]

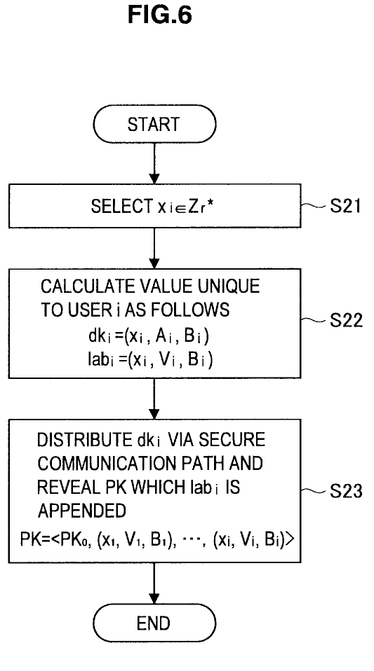

A join process, i.e., a method of generating a key, in a methodology according to Non-Patent Document 2 will now be described, in detail, with reference to FIG. 6. FIG. 6 is a flowchart illustrating the method of generating the key according to Non-Patent Document 2.

The join process is a user registration process performed by a central facility having an information processing apparatus according to this application example for each system subscription request from users. This process may be performed at any timing after the central facility has setup the system.

The central facility inputs public information PKᵢ₋₁ (1≦i≦n), a master key SK, and an index i for an i-th user, who has subscribed to the system, to the information processing apparatus 10 and performs the join process to be described later. Thus the central facility generates a secret key for a user who has sent a system subscription request and performs a subscription process for the user to the system.

First, a key generation unit 119 in the information processing apparatus 10 selects xᵢεZᵣ*, which is a value unique to each user i (step S21). Second, the key generation unit 119 in the information processing apparatus 10 calculates values shown in the following Eqs. (102), (103), and (104), and calculates a secret key dkᵢ (Eq. (105)) for the user i sending a system subscription request and a label labᵢ (Eq. (106)) (step S22). The label labᵢ is relevant to a public key for the user i.

$$\begin{matrix}{A}_{i} = \frac{{x}_{i}}{γ + {x}_{i}} G ∈ {G}_{1} & ( 102 ) \\ {B}_{i} = \frac{1}{γ + {x}_{i}} H ∈ {G}_{2} & ( 103 ) \\ {V}_{i} = {V}^{\frac{1}{γ + {x}_{i}}} ∈ {G}_{T} & ( 104 )\end{matrix}$$

dkᵢ=(xᵢ, Aᵢ, Bᵢ) (105)

labᵢ=(xᵢ, Vᵢ, Bᵢ) (106)

In this instance, although Bᵢ described in Eq. (103) is supposed to be a part of the secret key dkᵢ, Bᵢ is not secret information, but public information so that the user i may not keep Bᵢ secret.

The information processing apparatus 10 secretly distributes the secret key dkᵢ, which has been acquired by performing the join process, for the user to the user i via a secure communication path (step S23). In addition, the information processing apparatus 10 appends a label lab; =(xᵢ, Vᵢ, Bᵢ) corresponding to the user i to a current public key PKᵢ₋₁, and updates and reveals it as public information PK (step S23). At this moment, new public information PK is configured as described in the following Eq. (107).

PK=(PK₀, (x₁, V₁, B₁), . . . (xᵢ, Vᵢ, Bᵢ)) (107)

### [Encryption Method in Methodology According to Non-Patent Document 2]

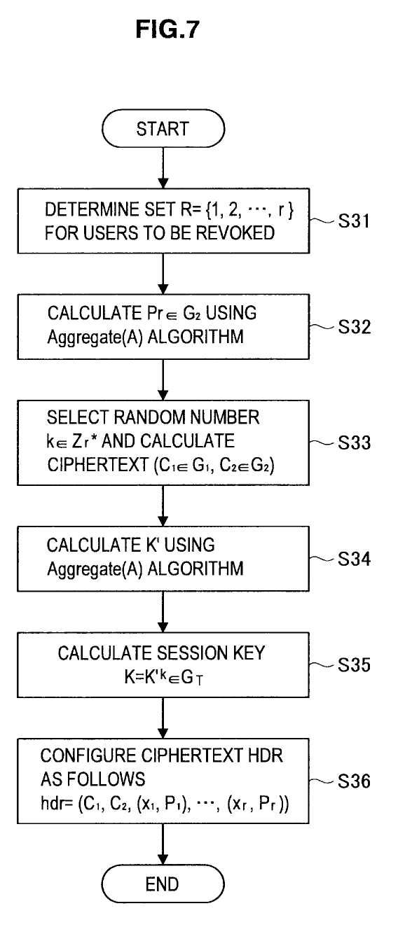

Referring to FIG. 7, we will now describe in detail an encryption process, i.e., an encryption method in a methodology according to Non-Patent Document 2. FIG. 7 is a flowchart illustrating the encryption method according to Non-Patent Document 2.

The encryption process is a process performed by any sender desiring to distribute contents for each distribution and so on using an encryption device 20 shown in FIG. 3.

The sender performs an encryption process on a plaintext such as a content, which the sender desires to distribute, by performing the encryption process to be described later. The encryption device 20 has CPU, ROM, RAM, a communication device, and so on, and performs the following process by means of CPU, ROM, RAM, the communication device, and so on.

First, the encryption device 20 determines a set R={1, . . . , r} for users to be revoked (step S31) and counts a number of elements of R to generate a count result r.

Second, the encryption device 20 performs a computational process of bilinear groups (Aggregate (A) algorithm) on operations on G₂ and calculates a value Pᵣ described in the following Eq. (108) (step S32). The Aggregate (A) algorithm that is a computational process algorithm of the bilinear groups will be described later in detail.

$${P}_{r} = \frac{1}{( γ + {x}_{1} ) ( γ + {x}_{2} ) … ( γ + {x}_{r} )} H ∈ {G}_{2} \qquad ( 108 )$$

Next, the encryption device 20 selects a random number kεZᵣ* and calculates a ciphertext (C₁, C₂) based on the following Eq. (109) and Eq. (110) (step S33).

C₁=kWεG₁ (109)

$${C}_{2} = \frac{k}{( γ + {x}_{1} ) ( γ + {x}_{2} ) … ( γ + {x}_{r} )} H ∈ {G}_{2} \qquad ( 110 )$$

The encryption device 20 then performs the computational process of the bilinear groups (Aggregate (A) algorithm) on operations on G_{T} and calculates a value described in the following Eq. (111) (step S34).

$${K}^{′} = {e ( G , H )}^{\frac{1}{( γ + {x}_{1} ) ( γ + {x}_{2} ) … ( γ + {x}_{r} )}} = {V}^{\frac{1}{( γ + {x}_{1} ) ( γ + {x}_{2} ) … ( γ + {x}_{r} )}} ∈ {G}_{T} \qquad ( 111 )$$

Once the calculation of Pᵣ and K′ has completed, the encryption device 20 calculates a session key K based on the following Eq. (112) (step S35).

K=(K′)^{k}εG_{T} (112)

The encryption device 20 then calculates a ciphertext hdr according to the following Eq. (113) (step S36).

$$hdr = ( {C}_{1} , {C}_{2} , ( {x}_{1} , {P}_{1} ) , … ( {x}_{r} , {P}_{r} ) ) \\ = ( kW , {kP}_{r} , ( {x}_{1} , {P}_{1} ) , … ( {x}_{r} , {P}_{r} ) ) \qquad ( 113 )$$

After generating a ciphertext of a plaintext M using the session key K, the encryption device 20 multicasts it along with the ciphertext hdr. By performing such processes, the sender can send encrypted contents and so on to requesting users.

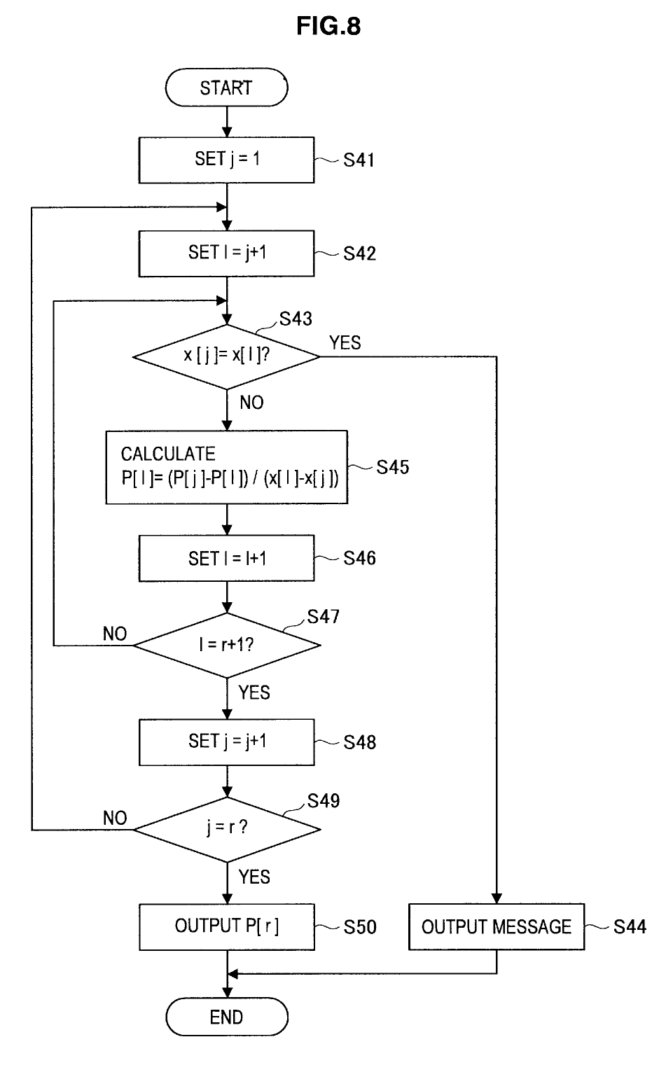

Referring to FIG. 8, we will now describe an Aggregate (A) algorithm, which is a computational process of bilinear groups implemented in an encryption process, in detail. FIG. 8 is a flowchart illustrating the computational process of the bilinear groups in a methodology according to Non-Patent Document 2.

The Aggregate (A) algorithm is an algorithm, which is performed by an encryption device in calculating (P₁, . . . , Pᵣ)εG₂ and K′εG_{T}. When performing this algorithm, x=[x₁, . . . , xᵣ] and P=[B₁, . . . , Bᵣ] are given as inputs to the algorithm.

First, an encryption device 20 sets a parameter j such that j=1 (step S41). Second, the encryption device 20 sets a parameter l such that l=j+1 (step S42).

In this instance, the encryption device 20 compares x[j] with x[l] (step S43) and outputs an error message when it is determined that x[j]=x[l] (step S44) and a process is terminated. Otherwise, i.e., when x[j]=x[l] is not satisfied, the encryption device 20 performs step S45 to be described later.

The encryption device 20 calculates P[l] using the following Eq. (114) (step S45).

$$P [ l ] = \frac{1}{x [ l ] - x [ j ]} ( P [ j ] - P [ l ] ) ∈ {G}_{2} \qquad ( 114 )$$

After completing this calculation of Eq. (114), the encryption device 20 increments l by 1 (step S46) and compares l with r+1 (step S47). When it is determined that l=r+1, the encryption device 20 performs step S48, otherwise, i.e., when l is not equal to r+1, the encryption device 20 returns the process to step S43 and continues processing.

Next, the encryption device 20 increments j by j+1 (step S48) and compares j with r (step S49). When it is determined that j=r, the encryption device 20 performs step S50, otherwise, i.e., when j is not equal to r, the encryption device return the process to step 42 and continues processing.

Thereafter, the encryption device 20 outputs P[r] (step S50).

It should be noted that K′εG_{T} can be calculated by means of the above-mentioned Aggregate (A) algorithm. In this case, it is sufficient to replace addition (subtraction) with multiplication (division) and multiplication with power, and then perform step S45 as an operation on G_{T}. However, in either case, an operation on Zᵣ*, i.e., 1/(x[l]−x[j]) should be calculated as subtraction and inverse element operation on Zᵣ*.

### [Decryption Method in Methodology According to Non-Patent Document 2]

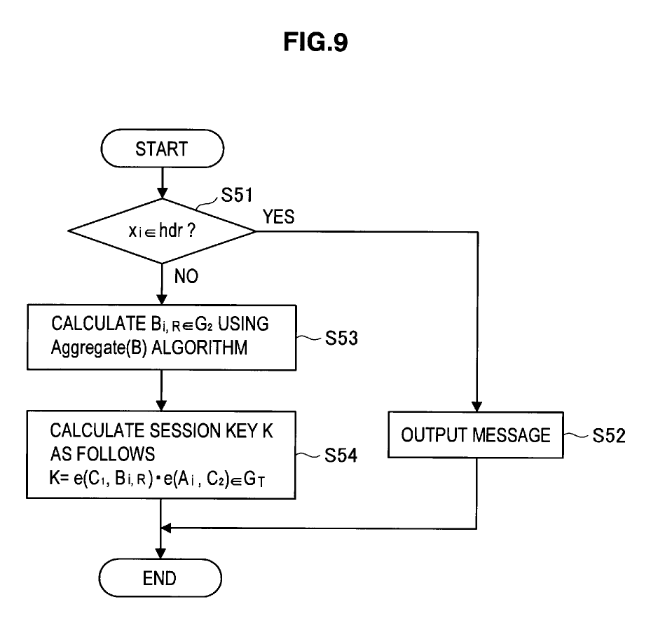

Referring to FIG. 9, we will now describe in detail a decryption process, i.e., a decryption method in a methodology according to Non-Patent Document 2. FIG. 9 is a flowchart illustrating the decryption method in the methodology according to Non-Patent Document 2.

The decryption process is a process performed by a decryption device 30 shown in FIG. 3, when any receiver, which has received distributed contents and so on, decrypts a ciphertext and gets a plaintext.

The decryption device 30 applies a decryption process to the distributed contents and so on by performing the decryption process to be described later based on hdr sent by a sender, a secret key dkᵢ specific to the decryption device 30, and a unique value specific to the decryption device 30. The decryption device 30 is a device being equipped with CPU, ROM, RAM, a communication device, and so on, and performing the following process using CPU, ROM, RAM, the communication device, and so on.

First, the decryption device 30 determines whether there is a unique value xᵢ specific to the decryption device 30 in the hdr sent from the sender (step S51). When it is determined that there is the unique value xᵢ specific to the decryption device 30 present in the hdr, a receiving device outputs a message to indicate that a receiver has been revoked by the sender (step S52) and terminates the process. Otherwise, i.e., when there is no unique value xᵢ specific to the decryption device 30 present in the hdr, the receiving device performs the following step S53.

Second, the decryption device 30 performs a computational process (Aggregate (B) algorithm) of bilinear groups and calculates a value shown in the following Eq. (115) (step S53). The Aggregate (B) algorithm, which is a computational process algorithm of the bilinear groups, will be described later in detail.

$${B}_{i . R} = \frac{1}{{\prod }_{j = 1}^{r} ( γ + {x}_{j} )} {B}_{i} = \frac{1}{( γ + {x}_{i} ) {\prod }_{j = 1}^{r} ( γ + {x}_{j} )} H ∈ {G}_{2} \qquad ( 115 )$$

After finishing step S53, the decryption device 30 calculates a session key K based on the following Eq. (116) using the calculated B_{i,R} (step S54).

$$\begin{matrix}K = e ( {C}_{1} , {B}_{i , R} ) \cdot e ( {A}_{i} , {C}_{2} ) \\ e ( k γ G , \frac{1}{( γ + {x}_{i} ) {\prod }_{j = 1}^{r} ( γ + {x}_{j} )} H ) \cdot \\ e ( \frac{{x}_{i}}{( γ + {x}_{i} )} G , \frac{k}{{\prod }_{j = 1}^{r} ( γ + {x}_{j} )} H ) \\ = {e ( G , H )}^{\frac{k γ}{( γ + {x}_{i} ) {\prod }_{j = 1}^{r} ( γ + {x}_{j} )} } \cdot {e ( G , H )}^{\frac{k {x}_{i}}{( γ + {x}_{i} ) {\prod }_{j = 1}^{r} ( γ + {x}_{j} )}} \\ = {e ( G , H )}^{\frac{k}{{\prod }_{j = 1}^{r} ( γ + {x}_{j} )}}\end{matrix} \qquad ( 116 )$$

The receiver decrypts a ciphertext of the contents sent from the sender and so on, and gets a plaintext by utilizing the session key K acquired by the above-mentioned decryption process.

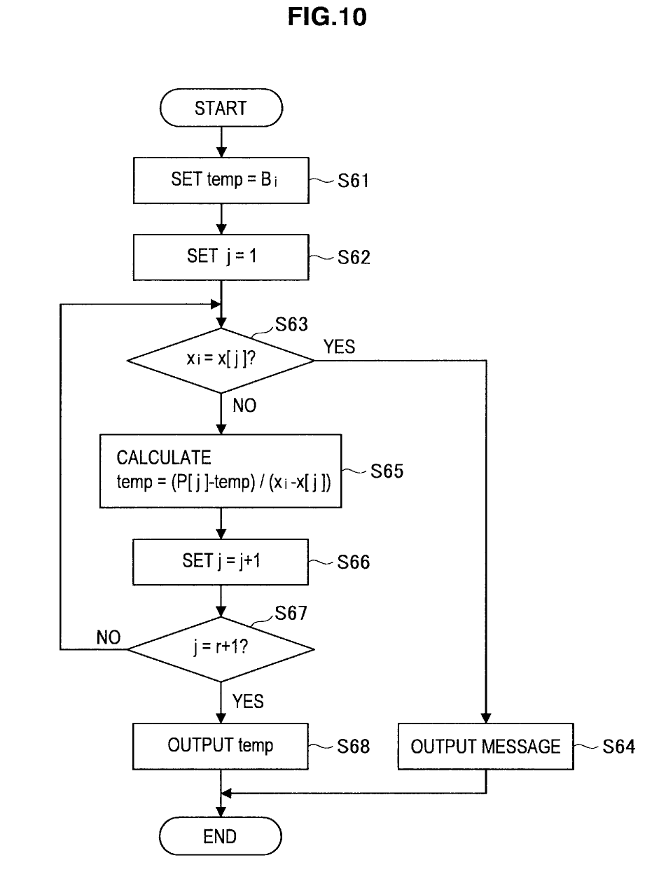

Referring to FIG. 10, we will now describe an Aggregate (B) algorithm, which is a computational process of bilinear groups implemented in a decryption process, in detail. FIG. 10 is a flowchart illustrating the computational process of the bilinear groups in a methodology according to Non-Patent Document 2.

The Aggregate (B) algorithm is an algorithm, which is performed by a decryption device 30 in calculating B_{i,R}εG₂. When performing this algorithm, Xᵢ, Bᵢ, x=[x₁, . . . , xᵣ] and P=[B₁, . . . , Bᵣ] are given as inputs to the algorithm.

First, the decryption device 30 sets a parameter temp such that an initial value of temp is Bᵢ (step S61) and sets a parameter j such that j=1 (step S62).

Second, the decryption device 30 compares xᵢ with x[j] (step S63) and outputs an error message when it is determined that xᵢ=x[j] (step S64) and a process is terminated. Otherwise, i.e., when xᵢ=x[j] is not satisfied, the decryption device 30 performs step S65 to be described later.

The decryption device 30 calculates a new value of temp using the following Eq. (117) (step S65).

$$temp = \frac{1}{{x}_{i} - x [ j ]} ( P [ j ] - temp ) ∈ {G}_{2} \qquad ( 117 )$$

In this instance, as can be appreciated from Eq. (117), since a denominator in this equation includes a unique value xᵢ specific to the decryption device 30, temp becomes null when hdr sent from the encryption device 20 includes xᵢ specific to the decryption device 30. Thus, since a revoked user may not get B_{i,R} necessary to calculate a session key K, the revoked user may not decrypt a plaintext.

After completing this computational process, the decryption device 30 increments a value of j by 1 (step S66) and compares j with r+1 (step S67). When it is determined that j=r+1, the decryption device 30 performs step S68 to be described later. Otherwise, i.e., when j is not equal to r+1, the decryption device 30 returns the process to step S63 and continues processing.

Thereafter, the decryption device 30 outputs temp (step S68). The output temp B_{i,R} and the decryption device 30 calculates the session key K using such an output value.

[Issues with Methodology According to Non-Patent Document 2]

In Non-Patent Document 2, a method of selecting specific groups G₁ and G₂ is not disclosed. As described above, in order to assure 128-bit security, it is necessary to let G₁ and G₂ be such that G₁=E(F_{q})[r] and G₂=E′(F_{q}²)[r] on an ordinary curve. In this instance, a BN curve, E: y²=x³+b, bεF_{q}, of an embedding degree k=12 will be employed as an elliptic curve. In addition, 6th order twist corresponding to the elliptic curve E is given by E′: y²=x³+b/D, DεF_{q}². Information amounts required for representing elements of the groups G₁ and G₂ are 512-bit and 1024-bit, respectively, and a computation cost of a group operation in the group G₂ is three times as high as that of a group operation in the group G₁.

In the method according to Non-Patent Document 2, when the groups are straightforwardly selected, an information processing apparatus, which does not implement an information processing method according to this embodiment, would select a generating element H from elements of a highly informative group G₂. Furthermore, each of an encryption device and a decryption device would perform most of an encryption process and a decryption process, respectively, on the highly informative group G₂. This causes an inefficiency in computation and information amounts for an entire cipher processing system.

Therefore, an application of the information processing method according to this embodiment makes it possible to reduce the computation and information amounts for the entire cipher processing system. In other words, the information processing apparatus 10, which is owned by a central facility, according to this application example calculates computation and information amounts for each of the groups G₁ and G₂ used as parameters in a setup process, and exchange the groups G₁ and G₂ depending on a determination result. As a result, while performing step S11 shown in FIG. 5, the information processing method according to this embodiment shown in FIG. 2 will be implemented.

### [Comparisons of Computation Amount and Information Amount]

We will now describe variations in a computation amount and an information amount when an information processing method according to this embodiment is applied to a methodology described in Non-Patent Document 2.

It is appreciated that there is no large difference no matter which of the computation amount or the information amount is selected as a determination parameter. It is also supposed that parameter setting in the operation is the same as that which has been described in connection with a pairing on an elliptic curve. Furthermore, let a total number n of users be 2²⁰=1,048,576 and a number r of revoked users (a number of users to be revoked) be 2¹⁰=1024. Then the computation amount and the information amount are compared between application and non-application of the information processing method according to this embodiment.

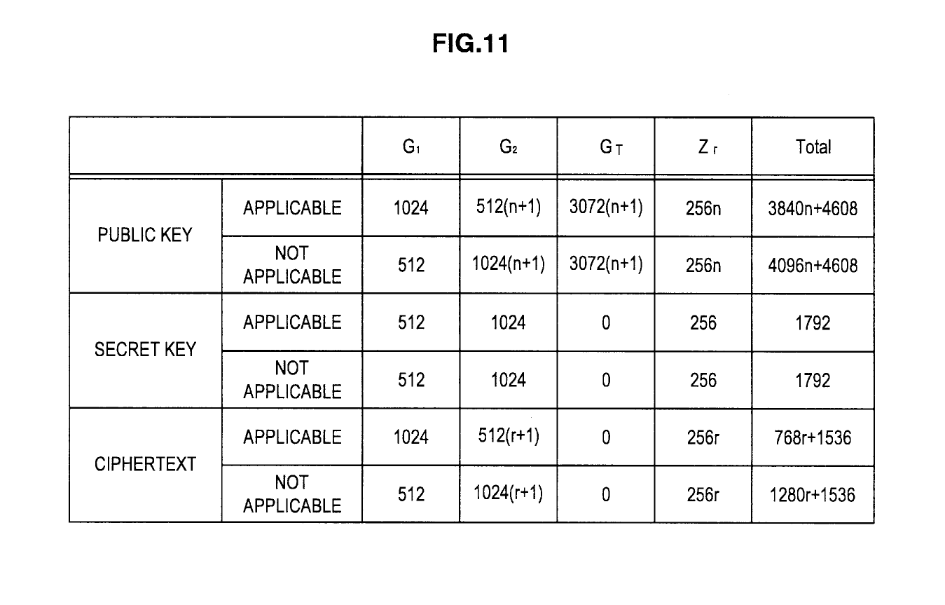

First, with reference to FIG. 11, a variation in an information amount will be examined. In FIG. 11, a unit of the information amount is represented by a unit of bit [bits].

Referring to FIG. 11, it is appreciated that, in the case of application of the information processing method according to this embodiment, on one hand, a total amount of information for a public key is 3840n+4608 bits, a total amount of information for a secret key is 1792 bits, and a total amount of information for a ciphertext is 768r+1536 bits.

In the case of non-application of the information processing method according to this embodiment, on the other, it is appreciated that the total amount of information for the public key is 4352n+4608 bits, the total amount of information for the secret key is 1792 bits, and the total amount of information for the ciphertext is 1280r+1536 bits.

Therefore, in the case of n=2²⁰ and r=2¹⁰, let be given such that 1 byte=8 bits. Then the computation of each information amount would be as follows. This means that, in the case of application, the total amount of information for the public key would be 503,317,056 bytes, the total amount of information for the secret key would be 224 bytes, and the amount of information for the ciphertext would be 98,496 bytes, on one hand. In the case of non-application, the total amount of information for the public key would be 570,425,920 bytes, the total amount of information for the secret key would be 224 bytes, and the amount of information for the ciphertext would be 164,032 bytes, on the other.

Consequently, it is appreciated that application of the information processing method according to this embodiment allows the information amount for the public key to be reduced by approximately 67 Mbytes, and the information amount for the ciphertext to be reduced by approximately 65 Kbytes.

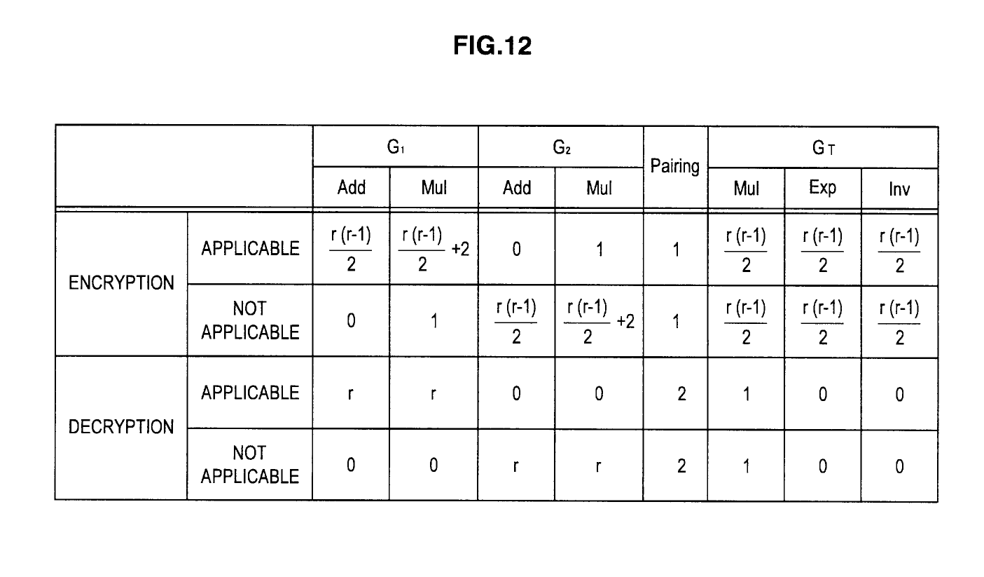

Second, with reference to FIG. 12, a variation in a computation amount will be examined. It should be noted that, in an example shown in FIG. 12, the computation amount is estimated with reference to a document, F. Hess, N. Smart, and F. Vercauteren, “The Eta Pairing Revisited,” IEEE TRANSACTION INFORMATION THEORY, VOL. 52, NO. 10, pp. 4595-4602, October 2006 (hereinafter, referred to as Non-Patent Document 3).

Let M be one-time multiplication on a field of definition, and let Ms be one-time multiplication on an s-th (=2ⁱ3^{j} th) degree expansion field. Then it could be estimated that a computation amount Ms=3ⁱ5^{j}M. In other words, M₂=3¹5⁰M=3M can be given by 2=2¹3⁰. Similarly, M₁₂=3²5¹M=45M can be given by 12=2²3¹.

In addition, let 14M and 12M be addition and double on a group G₁, respectively. Then addition and double on a group G₂ consisting of elements of a 2nd degree expansion field would be 14M₂=42M and 12M₂=36M, respectively.

It should be noted that an algorithm for calculation of scalar multiplication and power on each group may be achieved using a double and add method.

With reference to FIG. 12, it has been verified that, by calculating a computation amount for r=2¹⁰, the computation amount in the case of this application example will be reduced by 5,109,968,284 M for encryption and by 9,990,144 M for decryption in comparison with that of non-application.

### <Hardware Structure>

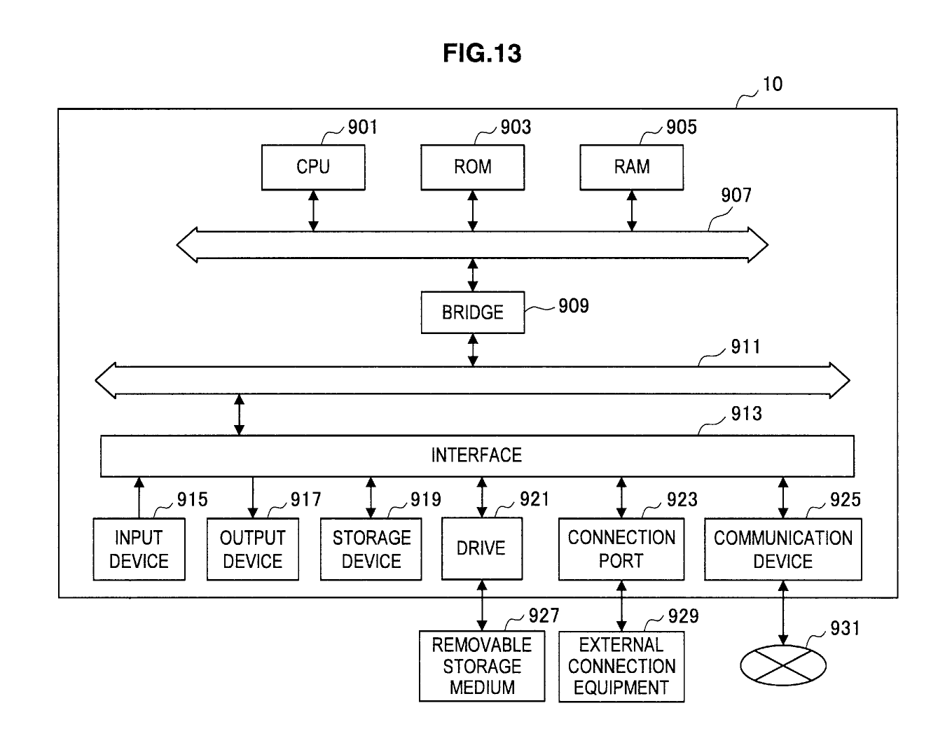

Referring to FIG. 13, we will now describe a hardware structure of an information processing apparatus 10 according to each embodiment of the present invention in detail. FIG. 13 is a block diagram illustrating the hardware structure of the information processing apparatus 10 according to each embodiment of the present invention.

The information processing apparatus 10 may mainly have CPU 901, ROM 903, and RAM 905. The information processing apparatus 10 may further have a host bus 907, a bridge 909, an external bus 911, a bus interface 913, an input device 915, an output device 917, a storage device 919, a drive 921, a connection port 923, and a communication device 925.

CPU 901 serves as a computing device and a controller and controls all or a part of operations in the information processing apparatus 10 in accordance with various programs recorded in ROM 903, RAM 905, the storage device 919 or a removable recording medium 927. The ROM 903 stores programs, operational parameters, and so on used by CPU 901. RAM 905 temporarily stores a program for use in execution by CPU 901, parameters that changes appropriately in the execution of the program, and so on. CPU, ROM, and RAM are connected with each other via the host bus 907 formed by an internal bus, such as a CPU bus.

The host bus 907 is connected to the external bus 911 such as a Peripheral Component Interconnect/Interface (PCI) bus via the bridge 909.

The input device 915 may be, for example, an operation device, such as mouse, a keyboard, a touch panel, a button, a switch, and a lever, which is operated by a user. The input device 915 may also be, for example, a remote control device (what is called remote controller) using infrared radiation or other radio waves, or may be an external connection equipment 929, such as a mobile telephone and PDA, adapted to the operation of the information processing apparatus 10. Furthermore, the input device 915 may include, for example, an input control circuit or the like, for generating an input signal based on information entered by the user using the above-mentioned operation device and outputting the input signal to CPU 901. The user of the information processing apparatus 10 can enter various data and instruct a processing operation to the information processing apparatus 10 by operating the input device 915.

The output device 917 includes a device capable of visually or audibly communicating acquired information to the user. Such device includes a display device, such as a CRT display device, a liquid crystal display device, a plasma display device, an EL display device and a lamp, an audio output device, such as a speaker and head phones, a printer, a mobile phone, a facsimile machine, and so on. In particular, the display device may present a result acquired by various processes preformed by the information processing apparatus 10 in the form of text or image, in one hand. The audio output device converts an audio signal including reproduced audio data, acoustic data, or the like to an analog signal and outputs the analog signal.

The storage device 919 is a data storing device, which is configured as an example of a storage unit of the information processing apparatus 10. The storage device 919 includes, for example, a magnetic storage device, such as a hard disk drive (HDD), a semiconductor storage device, an optical storage device, a magneto-optical storage device, or the like. The storage device 919 stores programs executed by CPU 901, various data, and various types of data acquired from outside.

The drive 921 is a reader/writer for a recording medium and may be embedded in or attached externally to the information processing apparatus 10. The drive 921 reads out information recorded in the removable recording medium 927, such as an attached magnetic disk, optical disk, a magneto-optical disk or semiconductor memory, and outputs the information to RAM 905. In addition, the drive 921 is capable of writing recordings to the removable recording medium 927, such as the attached magnetic disk, optical disk, magneto-optical disk, semiconductor memory, or the like. The removable recording medium 927 includes, for example, a DVD medium, a HD-DVD medium, a Blu-ray medium, and so on. The removable recording medium 927 may also be CompactFlash (CF) (registered trademark), a memory stick, a Secure Digital (SD) memory card, or the like. In addition, the removable recording medium 927 may be, for example, an Integrated Circuit (IC) card equipped with a non-contact IC chip, an electronic device, or the like.

The connection port 923 is a port used to directly connect an equipment to the information processing apparatus 10. One example of the connection port 923 may be a Universal Serial Bus (USB) port, an IEEE 1394 port including an i.LINK port, and a Small Computer System Interface (SCSI) port. Another example of the connection port 923 may be a RS-232C port, an optical audio terminal, a High-Definition Multimedia Interface (HDMI) port, or the like. By connecting the external connection equipment 929 to this connection port 923, the information processing apparatus 10 may acquire various data directly from the external connection equipment 929 and provide various data to the external connection equipment 929.

The communication device 925 may be, for example, a communication interface, which include a communication device portion for connecting to a communication network 931, and so on. The communication device 925 may be made in the form of a communication card for use in wired or wireless Local Area Network (LAN), Bluetooth, or Wireless USB (WUSB). The communication device 925 may be, for example, a router for use in optical communication, a router for use in Asymmetric Digital Subscriber Line (ADSL), a modem for use in various communication environments, or the like. For example, this communication device 925 is capable of sending/receiving signals and so on in conformity with a predetermined protocol, such as TCP/IP, to/from Internet and other communication equipments. Furthermore, the communication network 931 connected to the communication device 925 may be formed by networks connected via wired or wireless connection, and so on, and may be configured as, for example, Internet, home LAN, infrared communication, radio communication, satellite communication, or the like.

An example of a possible hardware structure for implementing features of the information processing apparatus 10 according to each embodiment of the present invention has been describe above. Each of the above components may be configured using a general purpose member, or may be configured with a dedicated hardware for a feature of each component. Thus the hardware structure used herein can be appropriately modified depending on state of the art at the time of implementing this embodiment.

### SUMMARY

As described above, in an information processing apparatus and an information processing method according to each embodiment of the present invention, a computation amount and an information amount for an entire operation scheme can be reduced in an operation utilizing a linear map.

It should be noted that it is possible to create a program to implement each feature of the information processing apparatus according each embodiment of the present invention and install the program into a personal computer and so on.

It should be understood by those skilled in the art that various modifications, combinations, sub-combinations and alterations may occur depending on design requirements and other factors insofar as they are within the scope of the appended claims or the equivalents thereof.

For example, an information processing apparatus and an information processing method according to the above-mentioned embodiments may be applicable to an improved version of a method described in Non-Patent Document 2, in which a computation amount or a size of a public key is reduced, or an ID based public key distribution method as described in Non-Patent Document 1.

The present application contains subject matter related to that disclosed in Japanese Priority Patent Application JP 2008-288395 filed in the Japan Patent Office on Nov. 11, 2009, the entire content of which is hereby incorporated by reference.

What is claimed is:

1. An information processing apparatus comprising:
a bilinear map selection unit for selecting a bilinear map used for a predetermined operation;
a group selection unit for selecting at least two types of groups G₁ and G₂ used in performing the operation;
a determination parameter calculation unit for calculating a determination parameter including at least either one of a computation amount required for the predetermined operation and an information amount for the predetermined operation based on each of the selected at least two types of the groups; and
a group decision unit for deciding a group used in performing the operation based on the determination parameter,
wherein the group decision unit exchanges contents of the groups G₁ and G₂ when the computation amount or information amount for the group G₂ is more than that for the group G₁.

2. The information processing apparatus according to claim 1, wherein
the information processing apparatus further includes a storage unit in which a detail of the operation using the bilinear map is recorded, and
the determination parameter calculation unit calculates the determination parameter with reference to the detail of the operation recorded in the storage unit.

3. The information processing apparatus according to claim 2, wherein
the group G₁ and the group G₂ are different from each other in that elements belonging to respective groups are different.

4. The information processing apparatus according to claim 2, wherein
the groups selected by the group selection unit are groups of a prime number order having a predetermined number of bits.

5. The information processing apparatus according to claim 1, wherein
the bilinear map is a map for points situated on an elliptic curve.

6. The information processing apparatus according to claim 5, wherein
the bilinear map is a Tate pairing.

7. The information processing apparatus according to claim 5, wherein
the bilinear map is an Ate pairing.

8. The information processing apparatus according to claim 1, wherein
the predetermined operation is an operation based on a public key distribution scheme.

9. The information processing apparatus according to claim 1, wherein
the predetermined operation is an operation based on an ID based public key distribution scheme.

10. An information processing method, comprising the steps of:
selecting a bilinear map used for a predetermined operation;
selecting at least two types of groups G₁ and G₂ used in performing the operation;
calculating a determination parameter including at least either one of a computation amount required for the predetermined operation and an information amount for the predetermined operation based on each of the selected at least two types of the groups; and
determining whether the computation amount or information amount for the group G₂ is more than that for the group G₁, and when it is affirmative, exchanges contents of the groups G₁ and G₂.

11. A program for causing a computer to execute:
a bilinear map selection process for selecting a bilinear map used for a predetermined operation;
a group selection function for selecting at least two types of groups G₁ and G₂ used in performing the operation;
a determination parameter calculation function for calculating a determination parameter including at least either one of a computation amount required for the predetermined operation and an information amount for the predetermined operation based on each of the selected at least two types of the groups; and
a function for determining whether the computation amount or information amount for the group G₂ is more than that for the group G₁, and when it is affirmative, for exchanging contents of the groups G₁ and G₂.
